(19) United States
(12) Patent Application Publication
(10) Pub. No.: US 2024/0372432 A1
(43) Pub. Date: Nov. 7, 2024

(54) DRIVE UNIT HAVING AN ELECTRIC MOTOR, A PLANETARY GEARBOX AND AN ELECTROMAGNETIC BRAKE

(71) Applicant: Maxon International AG, Sachseln (CH)

(72) Inventors: Florian HUPFER, Sachseln (CH); Nico WIRSICH, Sachseln (CH)

(21) Appl. No.: 18/289,327

(22) PCT Filed: May 9, 2022
(86) PCT No.: PCT/EP2022/062398

§ 371 Date: Nov. 2, 2023

(30) Foreign Application Priority Data
May 7, 2021 (EP) 21172746.6

(51) Int. Cl. H02K 7/00; B60K 7/00; B60K 17/04; H02K 7/106

(52) U.S. Cl. CPC H02K 7/006; B60K 7/0007; B60K 17/046; H02K 7/106; B60K 2007/0092

(57) ABSTRACT

The drive unit includes an electric motor which drives a motor shaft. The drive unit also includes a planetary gearbox which has a ring gear and has at least one first gear stage. The first gear stage has at least one planet gear. The drive unit also includes an electromagnetic brake with an excitation coil. The electromagnetic brake is arranged between the electric motor and the planetary gearbox. The excitation coil is accommodated at least in part in a recess in the ring gear.

### CROSS-REFERENCE TO RELATED APPLICATION

This application claims priority to and the benefit of PCT Patent Application No. PCT/EP2022/062398 filed on 9 May 2022, entitled “DRIVE UNIT HAVING AN ELECTRIC MOTOR, A PLANETARY GEARBOX AND AN ELECTROMAGNETIC BRAKE,” and European Patent Application No. 21172746.6, filed on 7 May 2021, entitled “DRIVE UNIT HAVING AN ELECTRIC MOTOR, A PLANETARY GEARBOX AND AN ELECTROMAGNETIC BRAKE”.

### BACKGROUND

### 1. Field

The present disclosure relates to a drive unit.

### 2. Related Art

A generic drive unit comprises an electric motor which drives a motor shaft and a planetary gearbox that has a ring gear. The planetary gearbox has at least one first gear stage, and the first gear stage has at least one planet gear. The drive unit also has an electromagnetic brake with an excitation coil. The electromagnetic brake is arranged between the electric motor and the planetary gearbox.

The CN 102170191 document shows a drive unit of short axial construction with an electric motor, a planetary gearbox and an electromagnetic brake. The planetary gearbox and the brake are arranged one behind the other and integrated radially in the center of the motor. This arrangement allows the axial length of the drive unit to be shortened, but requires a larger diameter of the drive unit. Accordingly, there is still a need for even more compact drive units with the components mentioned.

### SUMMARY

The present disclosure therefore aims to provide a drive unit of the generic type which allows a particularly compact structure of the drive unit, especially in the axial direction.

The problem is solved by the excitation coil being at least in part accommodated in a recess of the ring gear.

By accommodating the excitation coil at least in part in the recess of the ring gear, the drive unit can be of particularly compact structure, especially in the axial direction. In addition, the need for a coil body is dispensed with, which means that the drive unit can be of even more compact structure. Preferably, the planetary gearbox used has only one or two gear stages, if possible, so that the drive unit can have a particularly compact structure in the axial direction.

Preferred embodiments of the present disclosure are the subject-matter of the sub-claims.

According to a preferred embodiment of the present disclosure, the excitation coil is accommodated in the recess such that an axial extent of the planet gear overlaps at least 50%, preferably at least 70%, with an axial extent of the excitation coil. This arrangement allows the drive unit to be configured very compactly in the axial direction, since the axial extent of the planet gear and the associated axial extent of the ring gear in the area where the planet gear engages with the ring gear can be used to place the excitation coil.

In a particularly preferred embodiment of the present disclosure, an axial position of an end face of the excitation coil facing the electric motor either corresponds to an axial position of an end face of the planet gear facing the electric motor or the axial position of the end face of the excitation coil facing the electric motor is further away from the electric motor than the axial position of the end face of the planet gear facing the electric motor. This also enables a particularly compact structure of the drive unit, since the excitation coil is positioned relative to the planetary gearbox such that no additional axial installation space is required.

According to another preferred embodiment of the present disclosure, an annular groove forms the recess of the ring gear, wherein the annular groove is open on an end face of the ring gear facing the electric motor. Preferably, the annular groove and the ring gear are coaxial. A recess of the ring gear configured in such a way is easy and inexpensive to manufacture. In addition, the excitation coil can be easily placed in the annular groove.

Preferably, the excitation coil is accommodated in the recess such that the excitation coil is completely accommodated in the recess when viewed in the axial direction. This allows a compact structure of the drive unit.

According to another preferred embodiment of the present disclosure, the motor shaft forms a sun gear of the first gear stage of the planetary gearbox. This allows a simple structure of the drive unit. In addition, no additional components such as any drivers are required, which would increase the necessary installation space. Preferably, the ring gear is connected to a housing of the electric motor. Thus, the ring gear is a stationary ring gear. This also allows a simple and compact structure of the drive unit.

According to another preferred embodiment of the present disclosure, the electromagnetic brake comprises, in the axial direction starting from the electric motor, a pressure plate, a brake disk connected to the motor shaft, an armature plate and at least one biasing means. The brake has an applied condition in which the biasing means presses the armature plate onto the brake disk and the brake disk is thereby pressed onto the pressure plate. The brake has a released state in which the excitation coil pulls the armature plate toward it against a force of the biasing means due to an electromagnetic force generated by the excitation coil. An electromagnetic brake configured in such a way can be used in a preferred manner as a safety brake, since the brake switches to the applied state as soon as no more current flows through the excitation coil. In addition, such a brake can have an extremely compact structure. Preferably, the biasing means is at least one compression spring. This makes the biasing means a relatively inexpensive component that additionally requires few components or only one component and can thus be configured to be very compact.

In a particularly preferred embodiment of the present disclosure, an axial extent of the armature plate overlaps at least in part, preferably completely, with a part of the axial extent of the ring gear. As a result, the drive unit can be configured to be even more compact in the axial direction. Preferably, the armature plate has a circular opening and is configured coaxially with the ring gear. Thus, for example, a projection on the ring gear can lie in the circular opening, which holds a cover of the planet gear or a seal.

Preferably, the armature plate is held non-rotatably relative to the ring gear.

In a particularly preferred embodiment of the present disclosure, an intermediate plate of the electric motor, in particular a motor flange, forms the pressure plate. As a result, the drive unit can be configured in a particularly compact manner. Among other things, no additional pressure plate is required and one component can be dispensed with.

According to a further preferred embodiment of the present disclosure, the brake disk is directly connected to a motor pinion of the motor shaft. Preferably, the motor pinion, to which the brake disk is connected in a form-fitting manner, simultaneously forms the sun gear of the first gear stage of the planetary gearbox. Thus, no additional driver is required between the brake disk and the motor shaft, and the brake and the drive unit can be very compactly structured with few components.

According to a further preferred embodiment of the present disclosure, the biasing means is located in a recess of the ring gear. This also enables a more compact structure of the drive unit. Preferably, in the released state of the brake, the armature plate abuts against an end face of the ring gear facing the brake disk.

According to another preferred embodiment of the present disclosure, a spacer is arranged between a contact surface on the end face of the ring gear facing the electric motor and a surface of the pressure plate facing the brake disk. Thus, the axial distance between the pressure plate and the ring gear can be precisely fixed. This allows the braking effect of the brake to be set precisely.

In a particularly preferred embodiment of the present disclosure, the drive unit is a wheel drive. The very compact drive unit with the electromagnetic brake as a safety brake is suitable for a preferred wheel drive.

### BRIEF DESCRIPTION OF DRAWINGS

The disclosure is explained in more detail below with reference to drawings.

It is shown by:

FIG. 1: a longitudinal section of an embodiment of the drive system according to the disclosure, wherein for the sake of clarity, the electric motor is not shown in section,

FIG. 2: a detailed view of a longitudinal section of the embodiment of the drive system according to the disclosure.

### DESCRIPTION OF EMBODIMENTS

In the following explanations, the same parts are designated by the same reference signs. If a Figure contains reference signs which are not dealt with in detail in the associated Figure description, reference is made to the preceding or subsequent Figure descriptions.

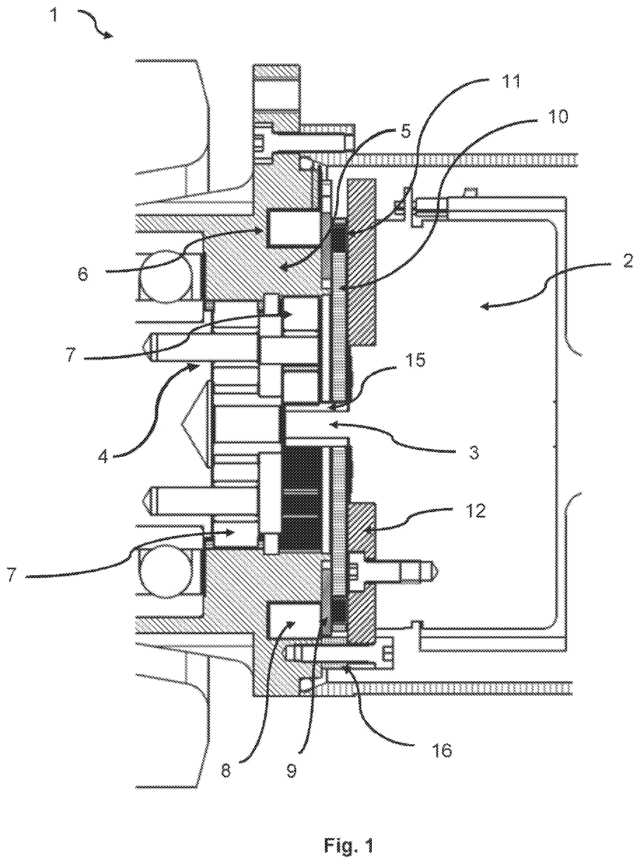

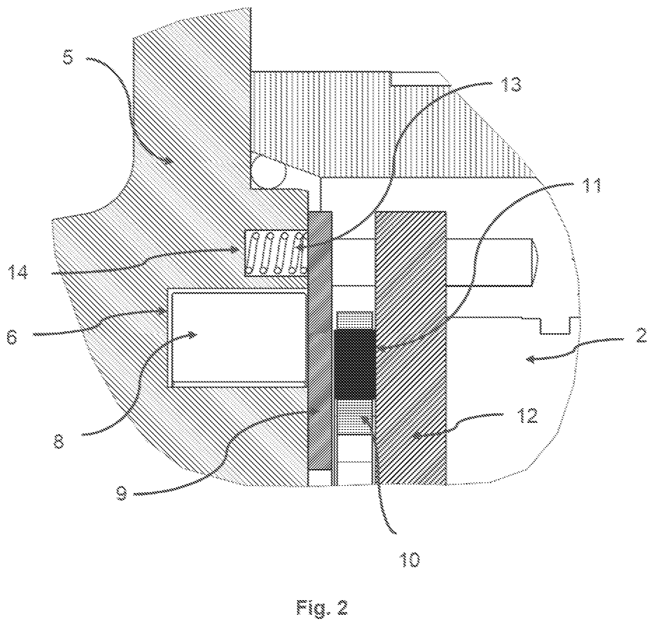

FIGS. 1 and 2 show longitudinal sections of an embodiment of the drive system 1 according to the disclosure. The electric motor is not shown in section in FIG. 1 for the sake of clarity. FIG. 2 shows only a detailed view of a longitudinal section. It should be noted that the longitudinal section of FIG. 2 does not correspond to that of FIG. 1. The section plane is rotated by an angle to the axis of the drive system 1.

The drive unit 1 according to the disclosure has an electric motor 2 which drives a motor shaft 3. A planetary gearbox 4 is connected to the motor pinion 15 of the motor shaft 3, wherein the motor shaft 3 forms the sun gear of the planetary gearbox 4 and the planetary gearbox 4 also has planet gears 7 and one ring gear 5. The planetary gearbox 4 is configured as a two-stage planetary gearbox. An electromagnetic brake is arranged between the electric motor 2 and the planetary gearbox 4. Components of the electromagnetic brake are an excitation coil 8, a biasing means in the form of compression springs 13, an armature plate 9, a brake disk 10 and a pressure plate 12.

The ring gear 5 has an annular groove 6 as a recess in the ring gear 5, in which the excitation coil 8 of the brake is accommodated and which is open towards an end face of the ring gear 5 facing the electric motor 2. In this context, the annular groove 6 is configured such that it completely accommodates the excitation coil 8, as viewed in the axial direction, wherein the excitation coil 8 fills the annular groove 6 to the greatest possible extent in order to achieve the highest possible winding density and thereby maximize the electromagnetic force that can be generated by the excitation coil 8 for its installation space. The excitation coil 8 is arranged in the annular groove 6 such that its end face facing the electric motor 2 has the same axial position as the end face of the planet gears 7 facing the electric motor 2.

In addition to the annular groove 6, the ring gear 5 also has further recesses 14 which are also open towards the end face of the ring gear 5 facing the electric motor 2 and in which biasing means in the form of compression springs 13 are seated. In the embodiment shown, these recesses 14 are arranged radially outside the annular groove 6.

Next to the end face of the ring gear 5 facing the electric motor 2 is arranged the armature plate 9, which is mounted non-rotatably to the ring gear 5 but movable in the axial direction of the drive unit 1. The armature plate 9 is arranged such that its axial extent at least in part overlaps with part of the axial extent of the ring gear 5. In particular, the armature plate 9 is configured as an annular disk, wherein a projection of the ring gear 5, which holds a cover of the planetary gearbox 4, extends in the axial direction into the opening of the annular disk/armature plate 9. On the one hand, the pressure forces of the pressure springs 13 act on the armature plate 9, pressing the armature plate 9 in the direction of the brake disk 10, which is arranged between the armature plate 9 and the pressure plate 12 in the axial direction. The electromagnetic forces of the excitation coil 8 act against the compressive forces of the compression springs 13 when the excitation coil 8 is correspondingly energized.

The brake disk 10 is directly connected to the motor pinion 15 of the motor shaft 3 and also has brake pads 11. If the armature plate 9 is now pressed onto the brake disk 10 or the brake pads 11 by the compressive forces of the compression springs 13 because the excitation coil 8 is no longer energized or the electromagnetic force of the excitation coil 8 is smaller than the compressive forces of the compression springs 13, the brake pads 11 of the brake disk 10 are simultaneously pressed onto the pressure plate 12. The brake disk 10 is thus pressurized from both sides and the electric motor 2 is braked via the form fit between the brake disk 10 and the motor pinion 15 of the motor shaft 3. This condition is also referred to as the applied condition of the brake. When the excitation coil 8 is now sufficiently energized again, the electromagnetic force of the excitation coil 8 acts against the compressive forces of the compression springs 13 and the armature plate 9 is pulled in the direction of the ring gear 5 so that the brake disk 10 can rotate again between the armature plate 9 and the pressure plate 12 with the motor shaft 3. The brake is thus in the released state.

In order to be able to set this interaction exactly, spacers 16 are arranged between the end face of the ring gear 5 facing the electric motor 2 and the end face of the pressure plate 12 facing the brake disk 10. These define the axial space in which the armature plates 9 and the brake disk 10 lie.

In the embodiment shown, the pressure plate 12 also forms the motor flange 12 of the electric motor 2. In this context, the motor flange 12 is screwed to the ring gear 5 with the spacers 16 as distance pieces. The ring gear 5 is thus a fixed ring gear. The screws and the spacers 16 can serve as guides for radial grooves in the armature plate 9, which is thereby mounted so that it is non-rotatable but axially movable.

Due to the fact that, on the one hand, no separate pressure plate is used and, on the other hand, the excitation coil 8 and the armature plate 9 overlap, mostly in part, in their axial extent with the axial extent of the ring gear 5, the drive unit 1 has a particularly compact structure in the axial direction. For this purpose, components such as a separate coil holder or a separate pressure plate can be dispensed with, thus saving both costs and weight.

In a preferred manner, such a drive unit 1 can be used as a wheel drive.

### LIST OF REFERENCE SIGNS

1 drive unit
2 electric motor
3 motor shaft
4 planetary gearbox
5 ring gear
6 annular groove
7 planet gear
8 excitation coil
9 armature plate
10 brake disk
11 brake pad
12 pressure plate/motor flange
13 compression spring
14 recess
15 motor pinion
16 spacer

1. A drive unit comprising:
an electric motor which drives a motor shaft,
a planetary gearbox having a ring gear, wherein the planetary gearbox has at least one first gear stage and wherein the first gear stage has at least one planet gear, and
an electromagnetic brake having an excitation coil, wherein the electromagnetic brake is arranged between the electric motor and the planetary gear and is adapted to brake the motor shaft, and
wherein the excitation coil is at least in part accommodated in a recess of the ring gear.

2. The drive unit according to claim 1, wherein the excitation coil is accommodated in the recess such that an axial extent of the planet gear overlaps at least 50% with an axial extent of the excitation coil.

3. The drive unit according to claim 1, wherein an axial position of an end face of the excitation coil facing the electric motor either corresponds to an axial position of an end face of the planet gear facing the electric motor or the axial position of the end face of the excitation coil facing the electric motor is further away from the electric motor than the axial position of the end face of the planet gear facing the electric motor.

4. The drive unit according to claim 1, wherein an annular groove forms the recess of the ring gear, wherein the annular groove is open on an end face of the ring gear facing the electric motor.

5. The drive unit according to claim 1, wherein the excitation coil is accommodated in the recess such that the excitation coil is completely accommodated in the recess when viewed in the axial direction.

6. The drive unit according to claim 1, wherein the motor shaft forms a sun gear of the first gear stage of the planetary gearbox.

7. The drive unit according to claim 1, wherein the electromagnetic brake comprises a pressure plate in the axial direction starting from the electric motor, a brake disk connected to the motor shaft, an armature plate and at least one biasing means, wherein the brake has an applied condition in which the biasing means presses the armature plate onto the brake disk, thereby pressing the brake disk onto the pressure plate, and wherein the brake has a released state in which the excitation coil pulls the armature plate toward it against a force of the biasing means due to an electromagnetic force generated by the excitation coil.

8. The drive unit according to claim 7, wherein an axial extent of the armature plate overlaps at least partially with a part of the axial extent of the ring gear.

9. The drive unit according to claim 7, wherein the armature plate (9) is held non-rotatably relative to the ring gear.

10. The drive unit according to claim 7, wherein an intermediate plate of the electric motor, in particular a motor flange, forms the pressure plate.

11. The drive unit according to claim 7, wherein the brake disk is directly connected to a motor pinion of the motor shaft.

12. The drive unit according to claim 7, wherein the biasing means is seated in a recess of the ring gear.

13. The drive unit according to claim 7, wherein a spacer is arranged between a contact surface on the end face of the ring gear facing the electric motor and a surface of the pressure plate facing the brake disk.

14. The drive unit according to claim 1, wherein the drive unit is a wheel drive.

15. The drive unit according to claim 2, wherein that the planet gear overlaps with the excitation coil is at least 70%.

16. The drive unit according to claim 8, wherein the armature plate overlaps completely with a part of the axial extent of the ring gear.
